(19) United States
(12) Patent Application Publication
(10) Pub. No.: US 2016/0028833 A1
(43) Pub. Date: Jan. 28, 2016

(54) TENANT AWARE SESSION MANAGER

(71) Applicant: VIOLETA GEORGIEVA, Sofia (BG)

(72) Inventor: VIOLETA GEORGIEVA, Sofia (BG)

(21) Appl. No.: 14/340,594

(22) Filed: Jul. 25, 2014

(51) Int. Cl. H04L 29/08

(52) U.S. Cl. CPC H04L 67/146; H04L 67/10

(57) ABSTRACT

Various embodiments of systems and methods to provide a tenant aware session manager for accessing a cloud application is described herein. In one aspect, a request to access the cloud application is received. A communication session corresponding to a current communication session ID associated with the request is determined. Upon determining the communication session, a current tenant ID is retrieved from the request. Further, a check is made to compare whether a tenant ID associated with the communication session matches with the current tenant ID. The communication session to execute the cloud application is returned when the tenant ID matches with the current tenant ID. When the tenant ID does not match with the current tenant ID, a new communication session is generated with a tenant ID same as the current tenant ID and the new communication session is returned to execute the cloud application.

### BACKGROUND

With cloud platform (e.g., HANA® Cloud Platform provided by SAP SE Company), services to multiple tenants from a single cloud application can be provided. Although the cloud application is shared among multiple tenants, each tenant may be associated with a separate database which includes data that may be accessed by the tenant. Such separate database requires individual maintenance and administrative efforts. These efforts include backup and recovery, lifecycle management (e.g., upgrades, change requests, testing) and tenant-specific adaptations (e.g., to address performance and/or disk space). The costs of these efforts may overwhelm savings achieved by using a single cloud application.

Therefore, to reduce database-related costs, a single database may be used to store the data of the subscribed tenants. A communication session manager keeps track on the created communication sessions for accessing the cloud application. When a request to access the cloud application is received from a tenant, the cloud application is executed based on a unique identifier of the communication session associated with the request. However, such a scenario may raise data security concerns as the session manager may not have knowledge of a current tenant and may return same communication session for different tenants.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates a system environment to provide access to a cloud application for multiple tenants, according to one embodiment.

FIG. 2 is a flow diagram illustrating a process to provide access to a cloud application for a tenant, according to an embodiment.

FIG. 3 is sequence diagram illustrating an exemplary data flow for determining a communication session corresponding to a request, according to an embodiment.

FIG. 4 is sequence diagram illustrating an exemplary data flow for determining a communication session corresponding to a request, according to an embodiment.

FIG. 5 is sequence diagram illustrating an exemplary data flow for generating a new communication session corresponding to a request, according to an embodiment.

FIG. 6 is a block diagram of an exemplary computer system, according to an embodiment.

### DETAILED DESCRIPTION

Embodiments of techniques to provide access to a cloud application for multiple tenants using a tenant aware session manager are described herein. Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

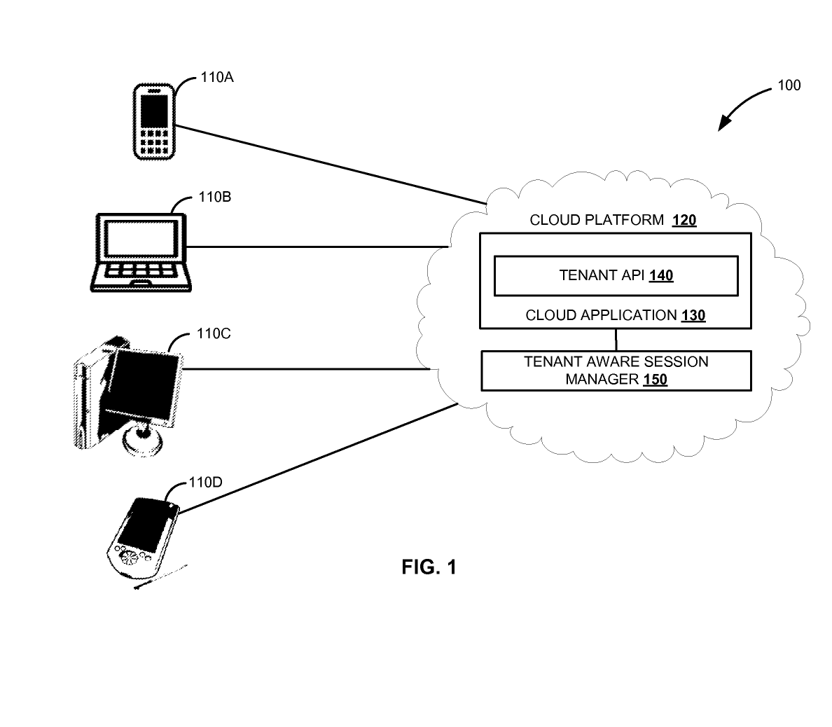

FIG. 1 illustrates system environment 100 to provide access to cloud application 130 for multiple tenants (e.g., 110A to 110D), according to one embodiment. The system environment 100 includes multiple tenants (e.g., 110A to 110D), which are subscribed to access the cloud application 130. Subscription refers to a contract between a cloud application provider and the tenants (e.g., 110A to 110D), who authorizes the tenants (e.g., 110A to 110D) to use the provider's cloud application 130. The cloud application 130 is developed on a cloud platform 120 (e.g., HANA® Cloud Platform provided by SAP SE Company). HANA® Cloud Platform is an in-memory cloud platform based on open standards and provides access to a feature-rich, easy-to-use development environment in the cloud. The cloud platform 120 includes a comprehensive set of services for integration, enterprise mobility, collaboration, and analytics.

The cloud application 130 can be accessed through a web browser from the tenants (e.g., 110A to 110D) connected to the Internet. The cloud application 130 may be provided as software-as-a-service (SaaS) application, platform-as-a-service (PaaS) application, or infrastructure-as-a-service (IaaS) application. In an embodiment, the cloud application 130 may be termed as “cloud for customer,” “cloud on-demand (COD),” or “on-demand” application. The cloud application 130 includes binaries (executable codes), application data, and application configuration. In various embodiments, the binaries include the application data and the application configuration.

Cloud application configuration refers to parameters which describe application properties and display, for example, display of various components or icons of the cloud application 130, cloud application logging information, and color, font, and size of the text rendered on the cloud application 130, and the like. The tenants (e.g., 110A to 110D) are configured to access the cloud application 130 upon subscribing to the cloud application 130. Further, the tenants (e.g., 110A to 110D) may be general purpose personal computers (including, by way of example, personal computers and/or laptop computers), cell phones or personal digital assistants (PDAs) and/or workstation computers running commercially-available UNIX or UNIX-like operating systems (including without limitation the variety of GNU/Linux operating systems). Alternatively, the tenants (e.g., 110A to 110D) may be any other electronic device, such as a thin-client computer, Internet-enabled gaming system, and/or personal messaging device, capable of communicating over a network. Although exemplary system environment 100 is shown with four tenants (e.g., 110A to 110D), any number of tenants may be supported.

The network via which the tenants (e.g., 110A to 110D) communicate with the cloud application 130 may be any type of network familiar to those skilled in the art that can support data communications using any of a variety of commercially-available protocols, including without limitation TCP/IP, SNA, IPX, AppleTalk, and the like. Merely by way of example, network 910 can be a local area network (LAN), such as an Ethernet network, a Token-Ring network and/or the like; a wide-area network; a virtual network, including without limiting to a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

In one embodiment, tenant aware session manager 150 keeps track on communication sessions (e.g., hypertext transfer protocol (HTTP) sessions) created for accessing the cloud application 130. An HTTP session is a sequence of network request-response transactions. The tenant (e.g., 110A to 110D) initiates a request by establishing a Transmission Control Protocol (TCP) connection to a particular port on a server associated with the cloud application 130. HTTP defines methods to indicate the desired action to be performed on the identified resource associated with the cloud application 130. When the tenant (e.g., 110A to 110D) login for a first time to access the cloud application 130, a communication session is created and a session ID associated with the created communication session is stored in the tenant aware session manager 150. In one exemplary embodiment, the tenant aware session manager 150 includes a structure to store the communication session IDs associated with the communication sessions. The communication session IDs or session token is a piece of data that is used in network communications (often over HTTP) to identify the communication session and a series of related message exchanges. Further, a tenant ID is extracted from the login credentials of the tenant (e.g., 110A to 110D).

At runtime, the request to access the cloud application 130 is received. In one embodiment, a tenant (e.g., one of 110A to 110D) accesses the cloud application 130 through a dedicated uniform resource locator (URL). When the request to access the cloud application 130 is received at the cloud platform 120, the tenant aware session manager 150 checks for a communication session corresponding to the received request by comparing a current communication session ID associated with the request and communication session IDs stored in the structure of the tenant aware session manager 150.

Upon determining the communication session associated with received request, a current tenant ID associated with the request and a tenant ID associated with determined communication session are compared. In one exemplary embodiment, the current tenant ID is retrieved from tenant application programming interface (API) 140 associated with the request. The tenant ID associated with the communication session is retrieved from login details of the tenant (e.g., 110A to 110D). Further, when the current tenant identifier (ID) and the tenant ID match, access to the cloud application 130 is provided. Therefore, the tenant aware session manager 150 provides access to the tenant (e.g., 110A to 110D) when the current communication session ID and the current tenant ID associated with the request is same as the communication session ID and the tenant ID of the communication session stored in the tenant aware session manager 150. Thereby data security of the tenants (e.g., 110A to 110D) is achieved.

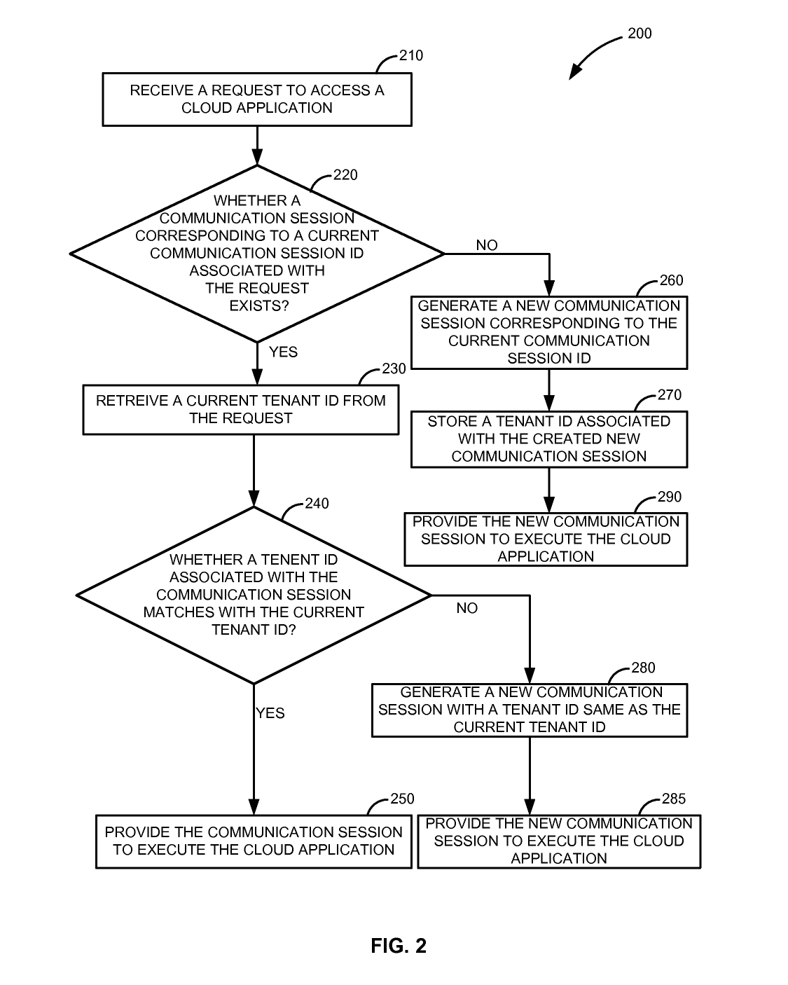

FIG. 2 is a flow diagram illustrating process 200 to provide access to a cloud application for a tenant, according to an embodiment. At 210, a request to access the cloud application is received from a tenant. In one embodiment, the request includes a tenant-specific uniform resource locator (URL) to access the cloud application (e.g., the URL can be “myapplication-tenantA.com,” where “tenantA” is tenant specific). The cloud application executes on a shared compute unit that can be accessed by multiple tenants.

At 220, a check is made to determine whether a communication session corresponding to a current communication session ID associated with the request exists in a tenant aware session manager. The communication session can be defined as a semi-permanent interactive information interchange, also known as a dialogue, a conversation or a meeting, between two or more communicating devices, or between a computer and a tenant. A communication session ID is granted to the tenant when the tenant accesses the cloud application for a first time. The communication session may be short-lived (e.g., the communication session ID may expire after a preset time of inactivity) and may become invalid after a certain goal has been met (e.g., once a buyer has finalized the order, the buyer cannot use the same communication session to add more items). In one exemplary embodiment, the communication session is identified by a communication session token or ID, in the form of a hash generated by a hash function that is generated and sent from a server to the tenant to identify the current communication session. For example, names that programming languages use when naming their cookie include JSESSIONID (JEE), PHPSESSID (PHP), and ASPSESSIONID (Microsoft® ASP).

At 230, upon determining the communication session corresponding to the current communication session ID, a current tenant ID is retrieved from the request. The current tenant ID, which is a unique identifier of the tenant, is retrieved from tenant API associated with the request. At 240, a check is made to compare whether a tenant ID associated with the communication session matches with the current tenant ID. The tenant aware session manager stores the communication session and the associated tenant ID (e.g., tenant information).

At 250, the communication session is provided to execute the cloud application when the tenant ID matches with the current tenant ID. On the other hand at 280, when the tenant ID does not match with the current tenant ID, a new communication session is generated with a tenant ID same as the current tenant ID. Further, the generated new communication session is provided to execute the cloud application, at 285.

In one embodiment, when there is no communication session in the tenant aware session manager corresponding to the current communication session ID, a new communication session corresponding to the current communication session ID of the request is generated, at 260. At 270, a tenant ID associated with the generated new communication session is stored. Further, the generated new communication session is provided to execute the cloud application, at 290.

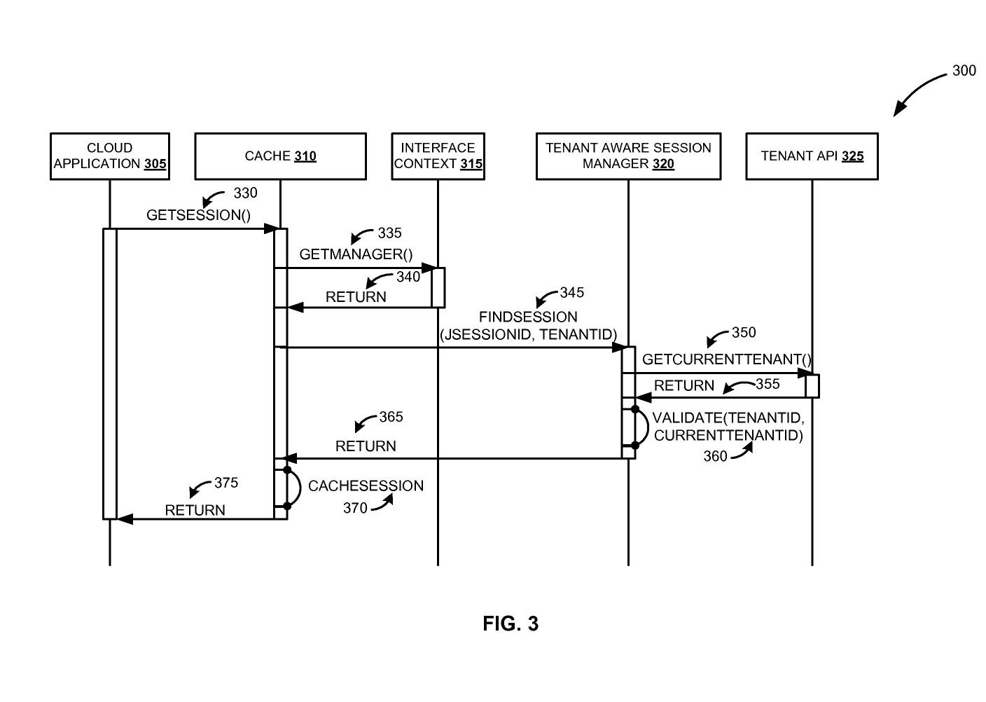

FIG. 3 is a sequence diagram illustrating exemplary data flow 300 for determining a communication session corresponding to a request, according to an embodiment. The sequence diagram represents the interactions and the operations involved in the method to retrieve the communication session corresponding to the request. FIG. 3 illustrates process objects including cloud application 305, cache 310, interface context 315, tenant aware session manager 320 and tenant API 325 along with their respective vertical lines originating from them. The vertical lines of the cloud application 305, the cache 310, the interface context 315, the tenant aware session manager 320 and the tenant API 325 represent the processes that may exist simultaneously. The horizontal lines (e.g., 330, 335, 340, 345, 350, 355, 365 and 375) represent execution of the method between the vertical lines originating from their respective process objects (e.g., the cloud application 305, the cache 310, the interface context 315, the tenant aware session manager 320 and the tenant API 325). Activation boxes (e.g., 360 and 370) represent the steps that are being performed in the respective process object (e.g., the cloud application 305, the cache 310, the interface context 315, the tenant aware session manager 320 and the tenant API 325).

When the request is received by the cloud application 305, an instruction to fetch the communication session corresponding to a communication session ID associated with the received request is sent to the cache 310 using query “getSession( )”, for instance (e.g., 330). The cache 310 is a component that transparently stores data or communication sessions so that future requests for that data can be served without fetching data from an original storage location. If the requested data is stored in the cache (e.g., cache hit), the request can be served by simply reading the cache, which is comparatively faster. Otherwise (e.g., cache miss), the data has to be recomputed or fetched from its original storage location.

In the example, the cache 310 does not include the communication session corresponding to the communication session ID associated with request. Therefore, the cache 310 fetch the communication session corresponding to the communication session ID from the tenant aware session manager 320. The cache 310 sends an instruction to fetch address of tenant aware session manager 320 to the interface context 315 using query “getManager( ), for instance (e.g., 335). In response to “getManager( ), the context return the address of the tenant aware session manager 320 (e.g., 340). The interface context 315 is a container that represents a servlet context, and therefore represents a web application in a web server. The interface context 315 includes information of the tenant aware session manager 320.

Further, the cache 310 sends a request to the tenant aware session manager 320 to find the communication session corresponding to the session ID associated with the request using query “findSession(JSESSIONID, TenantID),” for instance (e.g., 345). In the example, the communication session corresponding to the session ID exists, thereby the tenant aware session manager 320 validates a current tenant ID with a tenant ID associated with the communication session. The current tenant ID corresponding to the request is retrieved from tenant API 325 using query “getCurrentTenant( ),” for instance (e.g., 350 and 355). At 360, the tenant ID associated with the communication session and the current tenant ID are compared using query “Validate(TenantId, CurrentTenantId),” for instance. In the example, the tenant ID and the current tenant ID matches and the information is communicated to the cache 310 (e.g., 365). Therefore, a valid communication session corresponding to the received request is fetched and returned to the cloud application 305 and thereby the cloud application is executed.

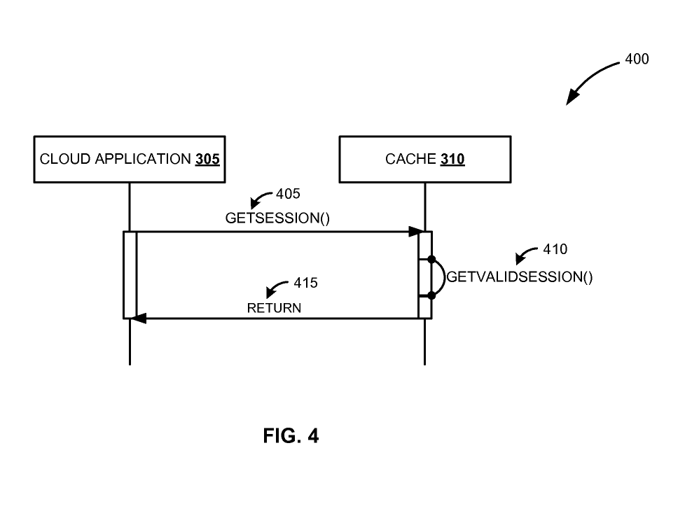

FIG. 4 is a sequence diagram illustrating exemplary data flow 400 for determining a communication session corresponding to a request, according to an embodiment. The sequence diagram represents the interactions and the operations involved in the method to retrieve the communication session corresponding to the request. FIG. 4 illustrates process objects including cloud application 305 and cache 310, along with their respective vertical lines originating from them. The vertical lines of the cloud application 305 and the cache 310 represent the processes that may exist simultaneously. The horizontal lines (e.g., 405 and 415) represent execution of the method between the vertical lines originating from their respective process objects (e.g., the cloud application 305 and the cache 310). Activation box 410 represents the step performed in the cache 310.

When the request is received by the cloud application 305, an instruction to fetch the communication session corresponding to a current communication session ID associated with the received request is sent to the cache 310 using query “getSession( )”, for instance (e.g., 405). The cache may store the communication session to provide access to the cloud application. In the example, the cache 310 includes the communication session corresponding to the communication session ID. The communication session is considered valid communication session when a communication session ID and a tenant ID associated with the communication session is same as the current communication session ID and a current tenant ID associated with the request. The communication session corresponding to the current communication session ID of the request is provided to the cloud application (e.g., 415) for executing the cloud application 305.

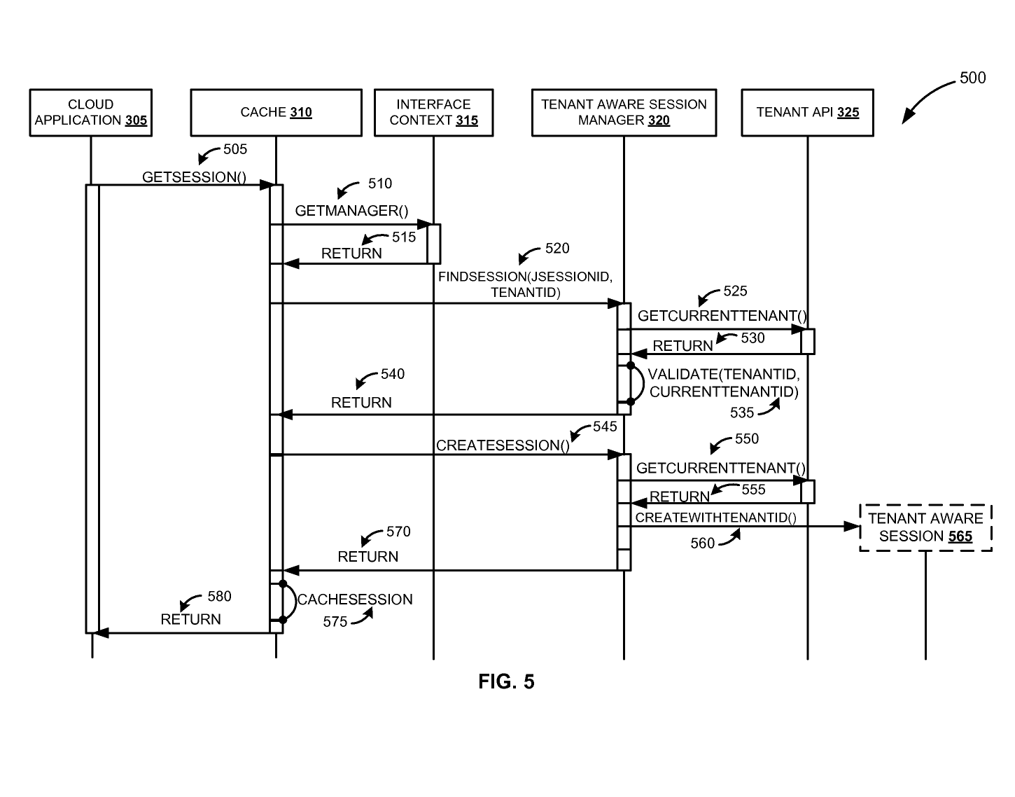

FIG. 5 is sequence diagram illustrating exemplary data flow 500 for creating a new communication session corresponding to a request, according to an embodiment. The sequence diagram 500 represents the interactions and the operations involved in the method to create the new communication session corresponding to the request. FIG. 5 illustrates process objects including cloud application 305, cache 310, interface context 315, tenant aware session manager 320 and tenant API 325 along with their respective vertical lines originating from them. The vertical lines of the cloud application 305, the cache 310, the interface context 315, the tenant aware session manager 320 and the tenant API 325 represent the processes that may exist simultaneously. The horizontal lines (e.g., 505, 510, 515, 520, 525, 530, 540, 545, 550, 555, 560, 570 and 580) represent execution of the method between the vertical lines originating from their respective process objects (e.g., the cloud application 305, the cache 310, the interface context 315, the tenant aware session manager 320 and the tenant API 325). Activation boxes (e.g., 535 and 575) represent the steps that are being performed in the respective process object (e.g., the cloud application 305, the cache 310, the interface context 315, the tenant aware session manager 320 and the tenant API 325).

When the request is received by the cloud application 305, an instruction to fetch the communication session corresponding to a communication session ID associated with the received request is sent to the cache 310 using query “getSession( )”, for instance (e.g., 505). In the example, the cache 310 does not include the communication session corresponding to the communication session ID associated with request. Therefore, the cache 310 fetch the communication session corresponding to the communication session ID from the tenant aware session manager 320. The cache 310 sends an instruction to fetch address of tenant aware session manager 320 to the interface context 315 using query “getManager( ), for instance (e.g., 510). In response to “getManager( ), the interface context return the address of the tenant aware session manager 320 (e.g., 515).

Further, the cache 310 sends a request to the tenant aware session manager 320 to find the communication session corresponding to the session ID associated with the request using query “findSession(JSESSIONID, TenantID),” for instance (e.g., 520). In the example, the communication session corresponding to the current communication session ID exists in the tenant aware session manager 320, thereby the tenant aware session manager 320 validates a current tenant ID with a tenant ID associated with the communication session. The current tenant ID corresponding to the request is retrieved from tenant API 325 using query “getCurrentTenant( ),” for instance (e.g., 525 and 530). At 535, the tenant ID associated with the communication session and the current tenant ID are compared using query “Validate(TenantId, CurrentTenantId),” for instance. In the example, the tenant ID and the current tenant ID does not match and the information is communicated to the cache 310 (e.g., 540). Therefore, a new communication session will be created with a tenant ID pointing to the current tenant ID.

At 545, a request to create the new communication session is sent to the tenant aware session manager 320 using query “createSession( ).” Upon receiving the request to create the new communication session, the tenant aware session manager 320 fetches the current tenant ID associated with the request (e.g., 550 and 555). Further, the tenant aware session manager 320 creates the new communication session (e.g., tenant aware session 565) associating the current tenant ID (e.g., 560). Thereby, the new communication session (e.g., tenant aware session 390) is created. The creation of the new communication session is communicated to the cache 310 (e.g., 570) and new cache session 575 is provided (e.g., 580) to the cloud application 305 to execute the cloud application 305. Therefore, when a valid communication session corresponding to the received request exists and when the tenant ID corresponding to the valid communication session does not match with the current tenant ID associated with the request, the new communication session is created. In one exemplary embodiment, when there is no valid communication session stored in the tenant aware session manager corresponding to the request, the new communication session is created.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may correspond to a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

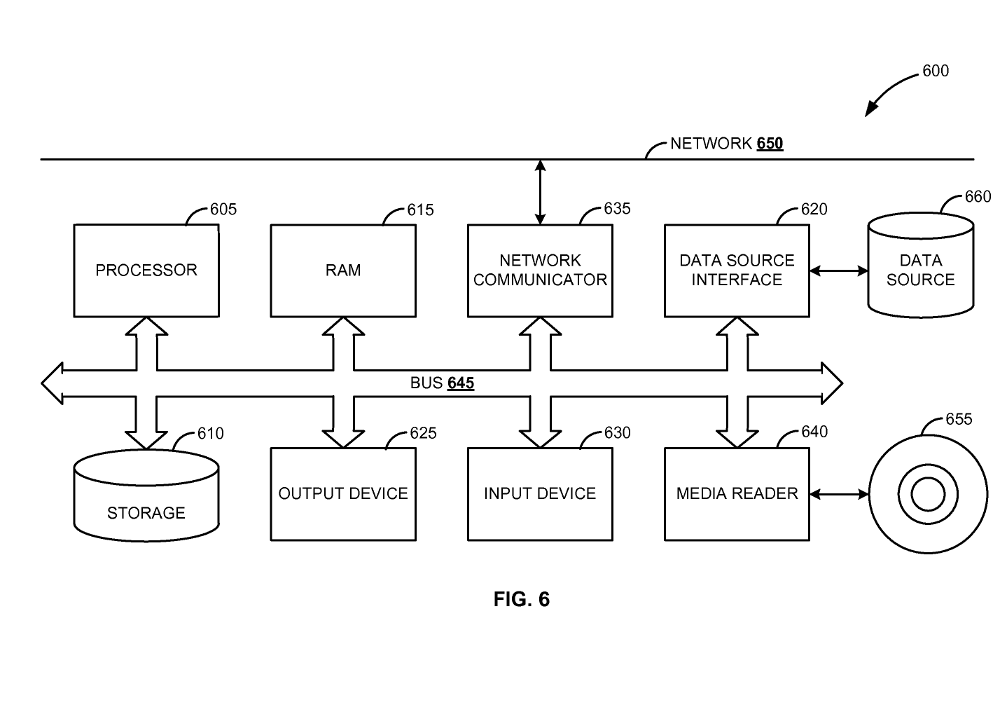

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium storing instructions, which when executed by a computer cause the computer to perform operations comprising:
receive a request to access a cloud application;
determine a communication session corresponding to a current communication session ID associated with the request;
upon determining the communication session, retrieve a current tenant ID from the request;
compare whether a tenant ID associated with the communication session matches with the current tenant ID; and
return the communication session to execute the cloud application when the tenant ID matches with the current tenant ID.

2. The non-transitory computer-readable medium of claim 1, wherein the request comprises a tenant-specific uniform resource locator (URL).

3. The non-transitory computer-readable medium of claim 1, further comprising instructions, which when executed cause the computer to:
generate a new communication session corresponding to the current communication session ID upon determining that no communication session corresponds to the current communication session ID;
store a tenant ID associated with the generated new communication session; and
return the new communication session to execute the cloud application.

4. The non-transitory computer-readable medium of claim 1, further comprising instructions, which when executed cause the computer to:
generate a new communication session with a tenant ID same as the current tenant ID when the tenant ID does not match with the current tenant ID; and
return the new communication session to execute the cloud application.

5. The non-transitory computer-readable medium of claim 1, wherein the cloud application executes on a shared compute unit accessed by multiple tenants.

6. The non-transitory computer-readable medium of claim 1, wherein the communication session and the associated tenant ID are stored in a tenant aware session manager.

7. The non-transitory computer-readable medium of claim 1, wherein the communication session is stored in a cache to provide access to the cloud application.

8. A computer implemented method to provide access to a cloud application for a tenant, the method comprising:
receiving a request to access the cloud application;
determining a communication session corresponding to a current communication session ID associated with the request;
upon determining the communication session, retrieving a current tenant ID from the request;
comparing whether a tenant ID associated with the communication session matches with the current tenant ID; and
returning the communication session to execute the cloud application when the tenant ID matches with the current tenant ID.

9. The computer implemented method of claim 8, wherein the request comprises a tenant-specific uniform resource locator (URL).

10. The computer implemented method of claim 8, further comprising:
generating a new communication session corresponding to the current communication session ID upon determining that no communication session corresponds to the current communication session ID;
storing a tenant ID associated with the generated new communication session; and
returning the new communication session to execute the cloud application.

11. The computer implemented method of claim 8, further comprising:
generating a new communication session with a tenant ID same as the current tenant ID when the tenant ID does not match with the current tenant ID; and
returning the new communication session to execute the cloud application.

12. The computer implemented method of claim 8, wherein the cloud application executes on a shared compute unit accessed by multiple tenants.

13. The computer implemented method of claim 8, wherein the communication session and the associated tenant ID are stored in a tenant aware session manager.

14. The computer implemented method of claim 8, wherein the communication session is stored in a cache to provide access to the cloud application.

15. A computer system to provide access to a cloud application for a tenant, the computer system comprising:
at least one processor; and
one or more memory devices communicative with the at least one processor, wherein the one or more memory devices store instructions to:
receive a request to access the cloud application;
determine a communication session corresponding to a current communication session ID associated with the request;
upon determining the communication session, retrieve a current tenant ID from the request;
compare whether a tenant ID associated with the communication session matches with the current tenant ID; and
return the communication session to execute the cloud application when the tenant ID matches with the current tenant ID.

16. The computer system of claim 15, wherein the request comprises a tenant-specific uniform resource locator (URL).

17. The computer system of claim 15, further comprising:
generating a new communication session corresponding to the current communication session ID upon determining that no communication session corresponds to the current communication session ID;
storing a tenant ID associated with the generated new communication session; and
returning the new communication session to execute the cloud application.

18. The computer system of claim 15, further comprising:
generating a new communication session with a tenant ID same as the current tenant ID when the tenant ID does not match with the current tenant ID; and
returning the new communication session to execute the cloud application.

19. The computer system of claim 15, wherein the communication session and the associated tenant ID are stored in a tenant aware session manager.

20. The computer system of claim 15, wherein the communication session is stored in a cache to provide access to the cloud application.
